(19) United States
(12) Patent Application Publication
(10) Pub. No.: US 2014/0012459 A1
(43) Pub. Date: Jan. 9, 2014

(54) System And Method To Instrument And Gather Three Dimensional (3-D) Vehicle Tracking And Information

(71) Applicant: BlueRadios, Inc., Englewood, CO (US)

(72) Inventors: Mark Kramer, Castle Rock, CO (US); Wilfred Tucker, Centennial, CO (US); John Sample, Centennial, CO (US); Christopher Bermel, Denver, CO (US)

(21) Appl. No.: 13/934,979

(22) Filed: Jul. 3, 2013

Related U.S. Application Data
(60) Provisional application No. 61/668,069, filed on Jul. 5, 2012.

(51) Int. Cl. G06F 17/00

(52) U.S. Cl. CPC G06F 17/00
USPC 701/31.4; 701/1

(57) ABSTRACT

A vehicle monitoring system and method of monitoring is described and taught. The monitoring system comprises, in part, a monitoring apparatus which attaches to a vehicle by way of a cigarette adapter, universal serial bus port, or the like. This enables the device to draw power from the vehicle's battery. The monitoring apparatus has a variety of sensing components which take readings based on the vehicle's movements and status. This information is sent via Bluetooth connection to a Bluetooth compatible device. The information can then be sent to a remote web server and uploaded into different interpretive software including three dimensional mapping software. The vehicle can then be maintained or serviced in a manner consistent with the data collected from the vehicle.

### CLAIM OF PRIORITY

This application claims priority to U.S. Application Ser. No. 61/668,069 filed on Jul. 5, 2012, the contents of which are fully incorporated by reference.

### FIELD OF THE INVENTION

The field of invention relates to systems and methods for monitoring vehicle status and the behavior of the driver or operator of the vehicle. In particular, using wireless technology to inexpensively retrofit vehicles with a monitoring device capable of communicating with a number of wireless devices and wireless protocols.

### BACKGROUND OF THE INVENTION

The invention of user driven vehicles has created an environment upon which we as a society have come heavily to rely. Over the years, innumerable safety features have been added or improved upon including safety belts, warning lights, alarms, and structural designs. A new, emerging safety feature market is that of vehicular monitoring and tracking. This has become popular with parents of new teen drivers as a way to monitor their behavior and to discuss driving safely.

Some monitorable features include driver behavior, fuel consumption, vehicle diagnostics, and location tracking. Existing systems are not perfect and have limitations to their use and practicality. One such limitation is that existing systems collect data from a plethora of sensors and/or the built-in vehicular instrumentation. This can result in mass quantities of information that is expensive to collect if the same methodology is applied to other vehicles. Additionally, the on-board diagnostics (OBD) port on passenger cars and light trucks serves to supply various data points pertinent to use and focuses primarily on engine performance not vehicle position, diver behavior, or location tracking. However, these ports are not necessarily present on heavy, industrial and commercial trucks and other such vehicles. The absence of these ports creates the need for a simple solution to monitor similar information.

Another limitation is the associated costs with the technology. The individual components required to complete a monitoring system each carry a heavy expense and cannot be retrofitted or updated in the field. A user must then purchase expensive software or pay for the services of another to interpret the data stream.

No prior art has fully addressed the issues at hand in the manner herein described. In view of the aforementioned limitations, there is a need for an improvement to the existing technology to combat these issues.

### SUMMARY OF THE INVENTION

According to a first aspect of the invention there is a monitoring system for a vehicle wherein the vehicle is capable of being user controlled, the system having a monitoring apparatus, and a wireless device the device being a Bluetooth® compatible device. In some embodiments, the Bluetooth® compatible device may have also Wi-Fi capabilities or both. The monitoring apparatus has a plurality of digital sensors including but not limited to a digital compass, digital accelerometer, digital gyroscope, global positioning system, and at least one sensor. The environmental sensors may vary but may comprise, but not limited to, any number of humidity sensors, carbon dioxide (CO₂) sensors, light sensors, temperature sensors, and sound sensors. The Bluetooth® compatible device must be within an operable range in relation to the monitoring apparatus.

The monitoring system may draw power from the vehicle and in some instances be able to harvest that power for use when the vehicle is in the “off” state. The monitoring system achieves this by either plugging into a cigarette adapter in the vehicle or in a universal serial bus port, if present, within the vehicle. The Bluetooth® compatible wireless device may take the form of a smart phone, laptop, PC, PDA, or the like. Additionally, the wireless device may act as a gateway and forward the collected data to a remote web server.

In another embodiment of the present invention there is a monitoring system for a vehicle lacking an on-board diagnostics (OBD) port, the monitoring system having a monitoring apparatus operably coupled to the vehicle, the monitoring apparatus having a digital compass, digital accelerometer, digital gyroscope, global positioning system and at least one sensor; and a wireless device having Bluetooth capabilities contained within a predetermined proximity to the monitoring apparatus.

According to a second aspect of the invention there is a method of monitoring a vehicle comprising attaching a monitoring apparatus to a vehicle, and forming an operable connection between the two, collecting information from the monitoring apparatus on a Bluetooth® enabled device, and interpreting the collected information using a three dimensional mapping software, and assessing the health and vehicular status compared to predetermined parameters. This collected information may then be forwarded to a remote web server. In some instances, the information is collected using a wireless device operating off a separate wireless standard or protocol such as Wi-Fi.

These and other embodiments will be better understood in conjunction with the drawings and descriptions that follow.

### BRIEF DESCRIPTION OF THE DRAWINGS

Embodiments of the present invention will now be described, by way of example only, with reference to accompanying drawings, in which:

FIG. 1 is a flow chart illustrating the data collection and interpretation according to an aspect of the present invention.

FIG. 2 is a flow chart illustrating a method of use according to an embodiment of the present invention.

### DETAILED DESCRIPTION

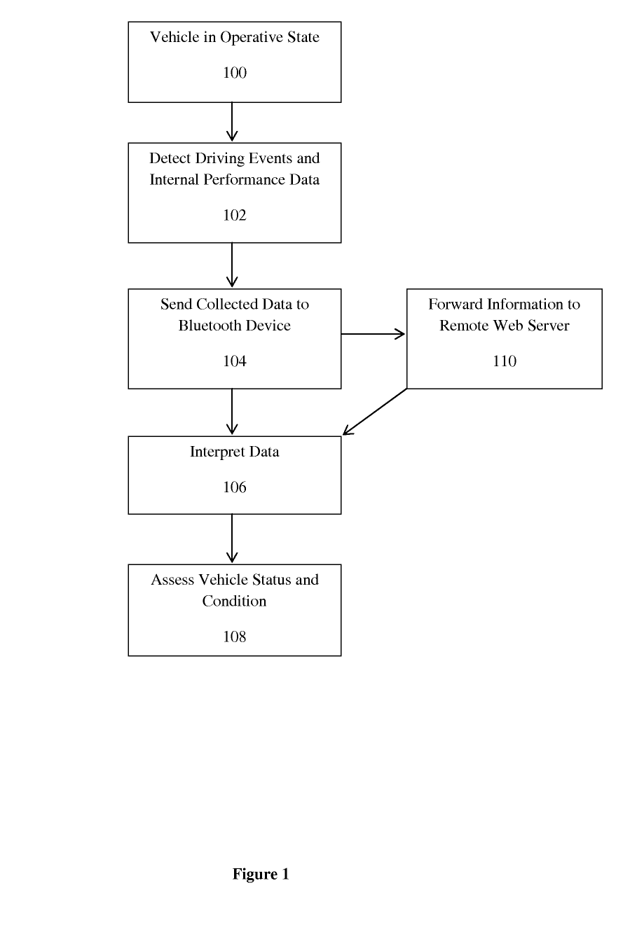

Referring to the drawings, FIG. 1 illustrates the data collection and interpretation process of a preferred embodiment of the present invention. A vehicle in an operative state 100 allows for data collection to occur. It is important to note that the vehicle in question may be any number or user driven or autonomous vehicle including but not limited to passenger cars, trucks, forklifts, backhoes, and unmanned vehicles. Once the vehicle is in an operative state 100 the data collection stream begins. The vehicle monitoring apparatus detects driving events and internal performance values 102 of the vehicle. This is achieved through by the apparatus' internal global positioning system, digital compass, accelerometer, and gyroscope. Each of these components can supply data critical to the monitoring of a vehicle.

The global positioning system permits any interaction with any of the GPS satellites in orbit. In order for a connection to be made, at least four of these satellites need to have their signal picked up by the internal GPS receiver. These signals contain the time the signal was transmitted, and the satellite position at the time of transmission. From this data, the internal

GPS receiver can deduce the position of the object associated with the GPS receiver. In some instances, it may be possible for only three satellite connections to be made, but this requires an outside known, fixed variable not normally associated with automobile traffic.

The digital compass, accelerometer and gyroscope all provide more detailed data than the GPS receiver. Whereas the GPS provides general location and movement, these components can provide information such lateral gravitational forces (i.e. automobile swerving on road) experienced by the automobile. Additionally, these components can provide a similar read out if the vehicle is in a location where there is not a sufficient GPS satellite coverage.

The apparatus also contains a number of different environmental sensor combinations including but not limited to carbon dioxide, light, temperature, humidity, sound, and the like. These sensors can monitor both the internal or external environment of the associated vehicle, Additionally, the system may monitor the vehicles battery or batteries for direct current voltage load changes. The system logs these changes to determine cycle times for turning load bearing electronics on/off.

The data is collected, compiled, stored, and time stamped in the onboard memory in the device. It may be preferential in some cases to send and store the data at a remote site. It is then sent to a Bluetooth® enabled device 104 for viewing, off load storage, and processing. As previously stated, the enabled device may also employ Wi-Fi for wireless data communications. Bluetooth® is a wireless communication standard operating in 2.4-2.8 GHz industrial, scientific, and medical (ISM) band, and is managed by the Bluetooth Special Interest Group (SIG). Wi-Fi is the name for products using IEEE 802.11 standard for wireless communication. Wi-Fi operates at a higher power than Bluetooth® permitting higher bit rates and a longer range from the base station.

These devices can be a number of devices including but not limited to laptops, PCs, PDAs, smart phones, digital cameras, and video game systems. The next step is to interpret the data 106. This can be achieved by loading the data points into interpretive software or by visual inspection. This may be achieved using any number of commercially available multi-dimensional mapping software. Alternatively, this data can be sent to a remote web server 110. Here, the process is the same as above, albeit there may be more options to interpret the data 106 based on the technological capabilities of each method.

With this interpretation having taken place, one can assess the health and operative status of the vehicle 108. There are preset parameters for different vehicles and these parameters can then be examined with relation to the collected data points. Differing values between such data can signify operable issues with the vehicle. For example, one may be able to measure the temperature of particular areas of the vehicle. An unusual temperature readout could signal a cooling mechanism is not working correctly or that there is undue friction occurring. The user may have an option of having an audible alarm emanating from the Bluetooth® enabled device or the monitoring apparatus itself if the data points are over a certain threshold in relation to accepted values for such data. Additionally, one can track in real time the location and movement of said vehicle.

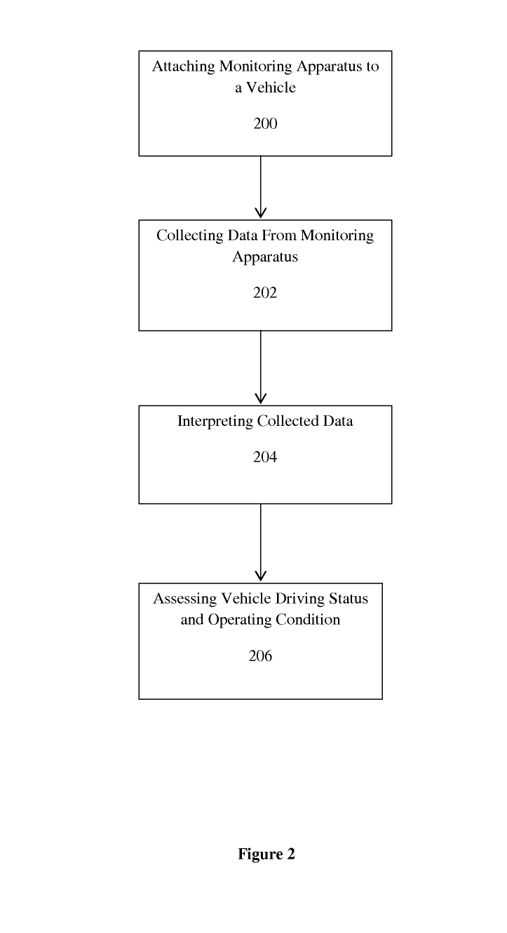

The methodology of applying such a monitoring system is described in FIG. 2. This first involves attaching the monitoring apparatus, as described above, to the desired vehicle 200. The vehicle is typically one that lacks an on-board diagnostics port. However, this is not a requirement. This is done by either using the cigarette adapter or by a universal serial bus connection (USB) present within the vehicle. Thus, the monitoring apparatus draws its power from the standard 12-volt battery or other battery system powering the vehicle. This battery power is sufficient to power the monitoring apparatus and to run any variety of programs or wireless protocols. In some instances, the device may be able to store energy from the vehicle's battery for use when not physically coupled to the vehicle. Once that has been done, the monitoring apparatus automatically begins collecting data 202. These data points can be varied depending on the exact makeup and qualities of the particular apparatus. The data is sent to a Bluetooth® or similar device and is then interpreted 204 or alternatively can be sent to a remote web server from the Bluetooth® or similar device for interpretation 204.

The interpreting of the data 204 may be accomplished via the input of the data points into commercially available three dimensional (3-D) mapping software. This permits the recreation of vehicle behavior through an augmented video. This user friendly feature allows for a visual representation of the data. Once this has been achieved, one can adequately assess the vehicle status and condition 206. This process is fairly straightforward and will likely involve comparing the measured and interpreted data points versus the accepted values for the specific make/model of the vehicle in question. These differences will signify what changes and/or maintenance must be performed on the vehicle.

What is claimed is:

1. A monitoring system for a vehicle lacking an on-board diagnostics port (OBD), the monitoring system comprising:
a monitoring apparatus operably connected to the vehicle, the monitoring apparatus having a digital compass, digital accelerometer, digital gyroscope, global positioning system and at least one sensor; and
a wireless device having Bluetooth capabilities contained within a predetermined proximity to the monitoring apparatus.

2. The monitoring system of claim 1 wherein the monitoring apparatus draws power directly from the vehicle.

3. The monitoring system of claim 1 wherein the wireless device can also operate off a Wi-Fi standard.

4. The monitoring system of claim 2 wherein the monitoring apparatus plugs into a cigarette adapter.

5. The monitoring system of claim 2 wherein the monitoring apparatus plugs into a universal serial bus (USB) port.

6. The monitoring system of claim 1 further comprising carbon dioxide, temperature, humidity, light, and sound sensors.

7. The monitoring system of claim 1 wherein the wireless device is a smart phone.

8. The monitoring system of claim 7 wherein the Bluetooth compatible device acts as a gateway and forwards information to a remote web server.

9. The monitoring system of claim 8 wherein the collected data is entered into three dimensional (3-D) mapping software.

10. The monitoring system of claim 1 wherein a vehicle battery is monitored for changes in voltage load.

11. A monitoring system for a vehicle wherein the vehicle is capable of being user controlled, the system comprising:
a monitoring apparatus operably connected to the vehicle, the monitoring apparatus having a plurality of monitoring sensors; and
a wireless device having Bluetooth capabilities contained within a predetermined proximity to the monitoring apparatus.

12. The monitoring system of claim 11 wherein the wireless device can also operate off a Wi-Fi standard.

13. The monitoring system of claim 11 wherein the monitoring apparatus plugs into a cigarette adapter or Universal Serial Bus (UBS) port.

14. The monitoring system of claim 11 wherein the monitoring apparatus has carbon dioxide, temperature, humidity, light, and sound sensors.

15. The monitoring system of claim 11 wherein the monitoring apparatus has a digital compass, digital accelerometer, digital gyroscope, and a global positioning system (GPS) receiver.

16. The monitoring system of claim 15 wherein the Bluetooth compatible device acts as a gateway and forwards information to a remote web server.

17. The monitoring system of claim 16 wherein the collected data is entered into three dimensional (3-D) mapping software.

18. The monitoring system of claim 1 wherein a vehicle battery is monitored for changes in voltage load.

19. A method of monitoring a vehicle comprising:
attaching a monitoring apparatus to a vehicle and forming an operable connection between the two bodies;
collecting data from the monitoring apparatus on a Bluetooth enabled device;
interpreting the collected data, wherein the collected data is interpreted using three dimensional mapping software; and
assessing vehicle status and health of operable condition when compared to preset vehicular parameters.

20. The method of claim 19 wherein collecting the data is achieved using a wireless device operating on a Wi-Fi standard.

21. The method of claim 19 wherein the vehicle lacks an on-board diagnostics port.
